(19) United States
(12) Patent Application Publication
(10) Pub. No.: US 2026/0087001 A1
(43) Pub. Date: Mar. 26, 2026

(54) REAL-TIME MULTIMODAL RETRIEVAL AUGMENTED GENERATION EMPOWERED LARGE LANGUAGE MODEL FOR NETWORK DOMAINS

(71) Applicant: Tata Communications (America) Inc., Reston, VA (US)

(72) Inventors: Ahmad Najib KHALIL, Red Bank, NJ (US); Phuong LUONG, East Brunswick, NJ (US)

(21) Appl. No.: 19/333,683

(22) Filed: Sep. 19, 2025

Related U.S. Application Data
(60) Provisional application No. 63/698,219, filed on Sep. 24, 2024.

(51) Int. Cl. G06F 16/242; G06F 16/22

(52) U.S. Cl. CPC G06F 16/243; G06F 16/2237

(57) ABSTRACT

A method and system include a Large Language Model (LLM) that generates a refined query based on a user query and a first set of contexts relevant to the user query, the first set of contexts retrieved from a preferred knowledge vector database. A second set of contexts relevant to the refined query are retrieved from the preferred knowledge vector database and a third set of contexts relevant to the refined query are retrieved from a domain-specific knowledge vector database. The LLM generates an answer to the refined query based on the second and third sets of contexts. The LLM generates a preferred query based on the user feedback about the answer generated by the LLM, the query, the refined query, and historical conversations. A user interface sends the user feedback, the historical conversations, and the preferred query received from the LLM to the preferred knowledge vector database for storage.

### RELATED APPLICATIONS

This application claims the benefit of U.S. Provisional Patent Application Ser. No. 63/698,219 filed on Sep. 24, 2024, which is incorporated herein by reference in its entirety.

### FIELD

The present disclosure relates to methods and systems for generating responses to queries submitted by a user, and in particular, to a Retrieval Augmented Generation method and system that integrates a user's feedback to refine the user's query.

### BACKGROUND

A Large Language Model (LLM) is an Artificial Intelligence (AI) program that uses a type of Machine Learning referred to as Deep Learning, to perform a variety of natural language processing tasks. LLMs typically comprise a plurality of neural networks, which process inputted queries (in the form of written text or human language), and generates output content. There are various methods for building an LLM application tailored to a specific discipline or field, i.e., knowledge domain.

One method involves training a base LLM from a blank state with a massive network dataset. This method requires enormous computation resources, expensive costs, and a massive, high-quality dataset.

Another method involves fine-tuning a pre-trained base LLM, which tends to reduce the complexity and cost of building a domain-specific LLM because it requires a smaller dataset. Although this method has several advantages, it still requires a high-quality dataset to obtain a remarkable improvement from the pre-trained base LLM. Additionally, it is not easy to frequently fine-tune the base LLM when the domain-specific information is updated or changed.

Still another method involves prompt-tuning, which is the simplest way for enabling an LLM to adopt to a new task. By providing the prompt with context and instructions, this guides the LLM to generate the desired response. For example, the recently released Generative Pre-trained Transformer 4 (GPT-4) model, which is a multimodal LLM, is capable of supporting a 128K token in the context window, where hundreds of pages of text can be fed to a prompt. Using prompt-tuning or prompt-engineering, the output of an LLM is highly impacted by the provided context and subtle instructions, which still require domain-specific expertise.

The Retrieval Augmented Generation (RAG) method combines an external knowledge database with the LLM to improve the LLM's output. The application of the RAG method solves the above-mentioned problems associated with prompt-tuning/prompt-engineering. Unlike the fine-tuning method, which requires additional training, the RAG method provides a quick and cost-effective way to integrate dynamic domain-specific knowledge to the LLM through a retrieval mechanism without the need to customize the LLM.

However, the RAG method still faces some limitations in understanding complex and ambiguous queries to retrieve relevant documents. Given a user's query, existing RAG methods refine and optimize the query by using different techniques, such as query expansion (e.g., expanding the query into multiple queries, chain of verification, sub-query, etc.), query rewriting, query routing (e.g., using a metadata filter or semantic router to route the query to a distinct RAG pipeline).

FIG. 1 is a swimlane flowchart, which illustrates the steps of a prior art RAG method. The RAG method of FIG. 1 uses an existing query or prompt engineering method to enable the LLM to rewrite the query before retrieving the relevant context. The RAG method FIG. 1 is executed by a system that includes a front end user interface 12 of an internet website, a retriever module 12 running on a backend server of the website, a pre-trained LLM 16 running on the backend server, and a domain-specific knowledge vector database 20, which is a component of a vector storage platform module running on an external server. Referring now to step 22 of FIG. 1, a user 10 inputs a query to the front-end user interface 12 of the internet website. In step 24, the query and a prompt to refine the query are transmitted by the front-end user interface 12 to the pre-trained LLM 16 running on the back-end server of the website. In step 26, the pre-trained LLM rewrites a new refined query based on the query inputted by the user and transmits the new refined query to the front-end interface 12 of the internet website. In step 28, the front-end interface 12 transmits the new refined query to the retriever module 14 running on the back-end server of the website. In step 30, the retriever module 14 transforms the new refined query into a vector and performs a semantic search in the domain-specific knowledge vector database 20 for relevant (top-k) documents. In step 32, the domain-specific knowledge vector database 20 returns top-k relevant documents hereinafter “relevant contexts” to the retriever module 14. Relevant contexts can include relevant text, images, tables, video files, audio files, etc. In step 34 the retriever module 14 transmits the relevant contexts to the front-end interface 12. In step 36, the front-end 12 interface transmits the new refined query and relevant contexts to the pre-trained LLM 16. In step 38, the pre-trained LLM 16 generates an answer in the form of text, images, tables, video files, and/or audio files etc. and transmits the answer to the front-end user interface 12 of the website for viewing by the user 10.

Table 1 sets forth a prior art RAG algorithm according to an illustrative embodiment, which can be used to implement the prior art RAG method of FIG. 1.

TABLE 1
Prior Art Algorithm: Query rewriting in RAG
Require: Generator LLM M, Retriever R, external domain-specific knowledge
vector database B = {d₁, ... , d_{N}}

| | |
|---|---|
| 1. | Input: User query q |
| 2. | LLM M rewrites a new query q* given q |
| 3. | Retriever R does semantic search over B to retrieve top-k documents |
| | F = {d₁, ... , dₖ} given q* |
| 4. | Prompt engineering: q* + F to prompt LLM M |
| 5. | LLM M generates completion y |

The above-described prior art RAG method and algorithm of FIGS. 1 and Table 1, respectively, do not integrate a user's feedback database to refine the user's query. Integrating the user's feedback to refine the user's query would advantageously align the RAG method to meet the user's expectation.

### SUMMARY

Disclosed herein is a method for answering a user query. In one embodiment, the method comprises: with a Large Language Model (LLM) of a computing device, generating a refined query based on the user query and a first set of contexts relevant to the user query retrieved from a first database; retrieving a second set of contexts from the first database that are relevant to the refined query; retrieving a third set of contexts from a second database that are relevant to the refined query; with the LLM, generating an answer to the refined query based on the second and third sets of contexts; and with the LLM, generating a preferred query based on feedback from the user, the query, the refined query, and historical conversations.

In various embodiments, the first, second, and third set of contexts, refer to distinct sets of information retrieved at different stages of the method (sequential search process used to answer complex queries).

In some embodiments, the method further comprises with a user interface, sending the feedback from the user, the historical conversations, and the preferred query received from the LLM, to the first database for storage.

In some embodiments of the method, the first database comprises a preferred knowledge vector database.

In some embodiments of the method, the first database comprises a preferred knowledge vector database, from which the first set of contexts that are relevant to the user query and the second set of contexts that are relevant to the refined query, are retrieved.

In some embodiments of the method, the second database comprises a domain-specific knowledge vector database, from which the third set of contexts that are relevant to the refined query, are retrieved.

In some embodiments, the method further comprises receiving user feedback about the answer generated by the LLM, at a user interface.

In some embodiments, the method further comprises sending, with the user interface, the feedback from the user, the query, the refined query, and historical conversations to the LLM prior to generating the preferred query.

In some embodiments of the method, the retrieving of the first set of contexts, the retrieving of the second set of contexts, and the retrieving of the third set of contexts, are each performed with a retriever module.

In some embodiments of the method, the computing device includes the retriever module.

In another embodiment, the method comprises with a Large Language Model (LLM) of a first computing device, generating a refined query based on a user query and a first set of contexts relevant to the user query, the first set of contexts retrieved from a preferred knowledge vector database of a second computing device; retrieving a second set of contexts relevant to the refined query from the preferred knowledge vector database of the second computing device; retrieving a third set of contexts relevant to the refined query from a domain-specific knowledge vector database of the second computing device; with the LLM, generating an answer to the refined query based on the second and third sets of contexts; at a user interface, receiving user feedback about the answer generated by the LLM; with the LLM, generating a preferred query based on the user feedback, the query, the refined query, and historical conversations received from the user interface; and with the user interface, sending the user feedback, the historical conversations, and the preferred query received from the LLM to the preferred knowledge vector database for storage.

In still another embodiment, the method comprises receiving a user query at a user interface; with the user interface, sending the query to a retriever module of a first computing device; with the retriever module, searching a preferred knowledge vector database of a second computing device for contexts relevant to the query; with the preferred knowledge vector database, returning a first set of contexts relevant to the query to the user interface; with the user interface, sending the first set of contexts and the query to a Large Language Model (LLM); sending a refined query, generated with the LLM, to the user interface; with the retriever module, searching the preferred knowledge vector database for contexts relevant to the refined query; with the preferred knowledge vector database, returning a second set of contexts relevant to the refined query to user interface; with the retriever module, searching a domain-specific knowledge vector database of the second computing device, for contexts relevant to the refined query; with the domain-specific knowledge vector database, returning a third set of contexts relevant to the refined query to the user interface; with the user interface, sending the refined query and the second and third sets of relevant contexts to the LLM; with the LLM, generating an answer to the refined query based on the second and third sets of relevant contexts; with the LLM, sending the answer to the user interface; receiving user feedback about the answer at the user interface; with the user interface, sending the user feedback, the query, the refined query, and historical conversations to the LLM; with the LLM, generating a preferred query based on the user feedback, the query, the refined query, and historical conversations; with the LLM, sending the preferred query to the user interface; and with the user interface, sending the user feedback, the historical conversations, and the preferred query to the preferred knowledge vector database for storage.

Further disclosed herein is a system for answering a user query. In one embodiment, the system comprises a computing device having a Large Language Model (LLM); first and second databases; and a user interface; wherein the LLM generates a refined query based on the user query and a first set of contexts retrieved from the first database and generates an answer to the refined query based on a second set of contexts retrieved from the first database that are relevant to the refined query and a third set of contexts retrieved from the second database that are relevant to the refined query; wherein the user interface receives user feedback about the answer generated by the LLM; wherein the LLM generates a preferred query based on the user feedback, the query, the refined query, and historical conversations received from the user interface.

In some embodiments of the system, the user interface sends the feedback from the user, the historical conversations, and the preferred query received from the LLM to the first database for storage.

In some embodiments of the system, the first database comprises a preferred knowledge vector database.

In some embodiments of the system, the first database comprises a preferred knowledge vector database, which provides the first set of contexts that are relevant to the user query and the second set of contexts that are relevant to the refined query.

In some embodiments of the system, the second database comprises a domain-specific knowledge vector database, which provides the third set of contexts that are relevant to the refined query.

In some embodiments of the system, the user interface receives the user feedback about the answer generated by the LLM.

In some embodiments of the system, the user interface sends the feedback from the user, the query, the refined query, and historical conversations to the LLM prior to generating the preferred query.

In another embodiment, the system comprises a first computing device having a preferred knowledge vector database and a domain-specific knowledge vector database; a second computing device having a Large Language Model (LLM); and a user interface; wherein the preferred knowledge vector database provides a first set of contexts, which are relevant to a user query received at the user interface; wherein the LLM generates a refined query based on the user query and the first set of contexts; wherein the preferred knowledge vector database provides a second set of contexts that are relevant to the refined query; wherein the domain-specific knowledge vector database provides a third set of contexts that are relevant to the refined query; wherein the LLM generates an answer to the refined query based on the second and third sets of contexts; wherein the user interface receives user feedback about the answer generated by the LLM; wherein the LLM generates a preferred query based on the user feedback, the query, the refined query, and historical conversations received from the user interface; and wherein the user interface sends the user feedback, the historical conversations, and the preferred query received from the LLM to the preferred knowledge vector database for storage.

In still another embodiment, the system comprises a first computing device having a Large Language Model (LLM) and a retriever module; a second computing device having a preferred knowledge vector database and a domain-specific knowledge vector database; and a user interface; wherein the user interface receives a user query and sends the query to the retriever module; wherein the retriever module searches the preferred knowledge vector database for contexts relevant to the query; wherein the preferred knowledge vector database returns a first set of contexts relevant to the query to the user interface; wherein the user interface sends the first set of contexts and the query to the LLM; wherein the LLM generates a refined query and sends the refined query to the user interface; wherein the retriever module searches the preferred knowledge vector database for contexts relevant to the refined query; wherein the preferred knowledge vector database returns a second set of contexts relevant to the refined query to user interface; wherein the retriever module searches the domain-specific knowledge vector database for contexts relevant to the refined query; wherein the domain-specific knowledge vector database returns a third set of contexts relevant to the refined query to the user interface; wherein the user interface sends the refined query and the second and third sets of relevant contexts to the LLM; wherein the LLM generates an answer to the refined query based on the second and third sets of relevant contexts and sends the answer to the user interface; wherein the user interface receives user feedback about the answer and sends the user feedback, the query, the refined query, and historical conversations to the LLM; wherein the LLM generates a preferred query based on the user feedback, the query, the refined query, and historical conversations and sends the preferred query to the user interface; and wherein the user interface sending the user feedback, the historical conversations, and the preferred query to the preferred knowledge vector database for storage.

### BRIEF DESCRIPTION OF THE DRAWING

FIG. 1 is a swimlane flowchart, which illustrates the steps of a prior art RAG method.

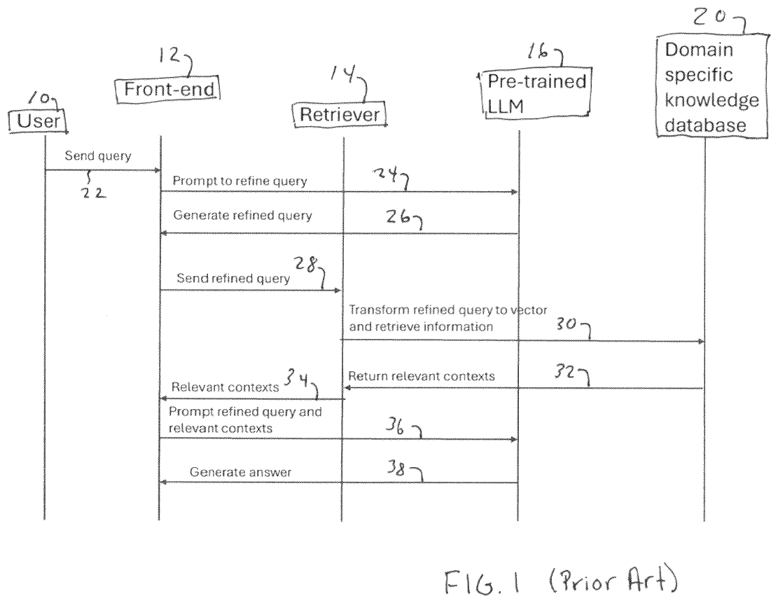

FIG. 2 is a block diagram of an illustrative embodiment of the RAG-based system of the present disclosure.

FIG. 3 is a swimlane flowchart that illustrates the steps of a RAG method executed by the RAG system of FIG. 2, according to an embodiment of the present disclosure.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same. Further, “connected” and “coupled” are not restricted to physical or mechanical connections or couplings.

Reference throughout this specification to “an embodiment,” “an illustrative embodiment,” in one embodiment,” “in another embodiment, or “in some embodiments” means that a particular feature, structure or characteristic described in connection with the embodiment is included in at least one embodiment of the disclosed embodiments. Thus, appearances of the above-quoted phrases throughout this specification are not necessarily all referring to the same embodiment. Furthermore, the particular features, structures or characteristics may be combined in any suitable combinations and/or sub-combinations in one or more embodiments. In addition, it is appreciated that the figures provided herewith are for explanation purposes to persons ordinarily skilled in the art.

Embodiments disclosed herein can be implemented as an apparatus, method, or computer program product. Accordingly, the disclosed embodiments can take the form of an entirely hardware embodiment, an entirely software embodiment (including firmware, resident software, micro-code, etc.), or an embodiment combining software and hardware aspects that can all generally be referred to herein as a “module” or “system.” Furthermore, the present embodiments can take the form of a computer program product embodied in any tangible medium of expression having computer-usable program code embodied in the medium.

Any combination of one or more computer-usable or computer-readable media can be utilized. In some embodiments, a computer-readable medium can include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the disclosed embodiments can be written in any combination of one or more programming languages.

The embodiments disclosed herein can also be implemented in cloud computing environments, which enable on-demand network access to a shared pool of configurable computing resources (e.g., networks, servers, storage, applications, and services) that can be rapidly provisioned and released with minimal management effort or service provider interaction, and then scaled accordingly.

The RAG-based system and method of the present disclosure provide a query that is refined and optimized from a users' feedback, historical conversation (the record of prior interactions between a user and the pre-trained LLM, which can be leveraged to provide more contextually relevant responses) and retrieved top-k relevant documents/contexts of similar queries through augmenting the pre-trained LLM.

The RAG-based system of the present disclosure provides a comprehensive domain-specific LLM architecture that uses a RAG-based algorithm to integrate knowledge from an external domain-specific data source and a user's preferences data, into an LLM. The present disclosure's RAG-based system provides a query refinement method learned from human feedback data. More particularly, the query refinement method of the present disclosure infers preferred queries via an LLM based on user feedback, historical conversations, and previously retrieved contexts. Given an input query, the query refinement method of the present disclosure retrieves relevant preferred queries and produces one and typically multiple new refined queries. By using the new refined query/queries, the RAG-based system of the present disclosure retrieves contexts that are relevant to the refined query/queries and generates the response.

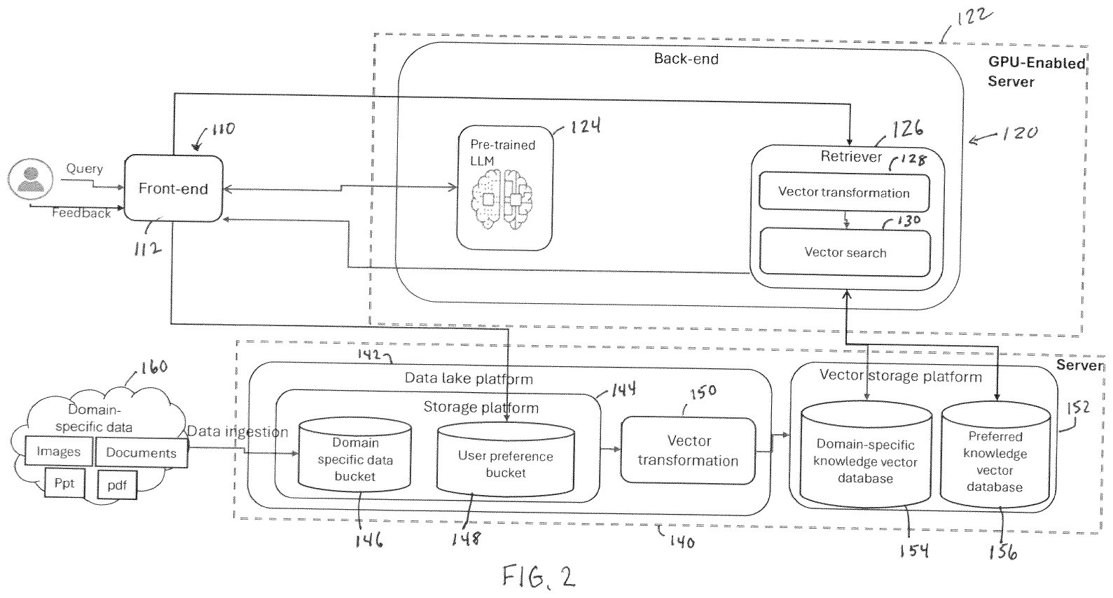

FIG. 2 is a block diagram of an illustrative embodiment of the RAG-based system of the present disclosure. The RAG-based system comprises an internet website 100 that includes a front-end 110 and a back-end 120. The front end 110 defines a user interface 112 that includes software and/or hardware, which enables a user to enter and transmit queries and feedback to the back-end 120 of the website 100. The back-end of the internet website 100 comprises a GPU-enabled server 122 or any other suitable computing device. The server 122 includes a pre-trained LLM 124 and a retriever module 126, which can each be implemented in software executed by the server 122. The pre-trained LLM 124 can be any existing off-the-shelf pre-trained LLM including without limitation a pre-trained multimodal LLM. The retriever module 126 includes a vector transformation module 128 that transforms the user's query into a vector and a vector search module 130 that searches for and retrieves preferred information/knowledge vectors.

The RAG-based system further comprises a data pipeline server 140 that includes a data lake platform module 142 and a vector storage platform module 152, which can each be implemented in software executed by the data pipeline server 140. The data lake platform module 142 includes a storage platform submodule 144 and a vector transformation submodule 150. The storage platform submodule 144 includes a domain-specific data bucket 146 that ingests and stores large amounts of domain-specific data 160 including: images; text documents; PowerPoint Presentations; PDFs; graphs; diagrams, etc., and a user preference bucket 148 that stores: all users' historical conversations (includes users' queries and LLM's responses, e.g., refined queries); all users' feedback and all users' preferred queries inferred by the LLM received from the user interface 112; and all retrieved relevant contexts (i.e., top-k relevant documents). It should be understood that the process of ingesting and storing domain-specific data 160 in the domain-specific data bucket 146 is typically performed before a user starts using the system and is a continuing process with domain-specific data 160 being continuously added and updated in the domain-specific bucket 146. The vector transformation submodule 150 transforms the domain-specific data 160 stored in the domain-specific bucket 146 and all users' historical conversations, feedback, preferred queries, and retrieved relevant contexts stored in the user preference bucket 148, into domain-specific knowledge vectors and preferred knowledge vectors, respectively. The vector storage platform module 152 includes a domain-specific knowledge vector database 154 that stores the domain-specific knowledge vectors transformed by the vector transformation submodule 150 which correspond to the ingested images, text documents, PowerPoint Presentations, PDFs, graphs, diagrams, etc. The vector storage platform module 152 further includes a preferred knowledge vector database 156 that stores preferred knowledge vectors transformed by the vector transformation submodule 150 which correspond to all users' historical conversation, feedback, preferred queries, and retrieved relevant contexts. In the beginning, the preferred knowledge vector database 156 is empty as there are no historical conversations feedback preferred queries, and retrieved relevant contexts.

For example, but not limitation, an original query could comprise: “Is there any thing wrong with my network?” The refined query returned by the pre-trained LLM 124 could comprise: “Can you check all the devices in the network reachable through ping?” The retrieved relevant contexts could comprise the status of all devices in the network. The response generated by the pre-trained LLM 124 is based, according to the present disclosure, on the refined query and the retrieved relevant contexts: “I found some devices are unreachable in the network.” The user feedback could comprise: “You may need to do the trace route command to find the potential issue causing the unreachable devices.” The preferred query returned by the pre-trained LLM 124 could comprise: “Can you check all the devices in the network reachable through ping and analyze the path to all unreachable devices through trace route to find the potential issue.”

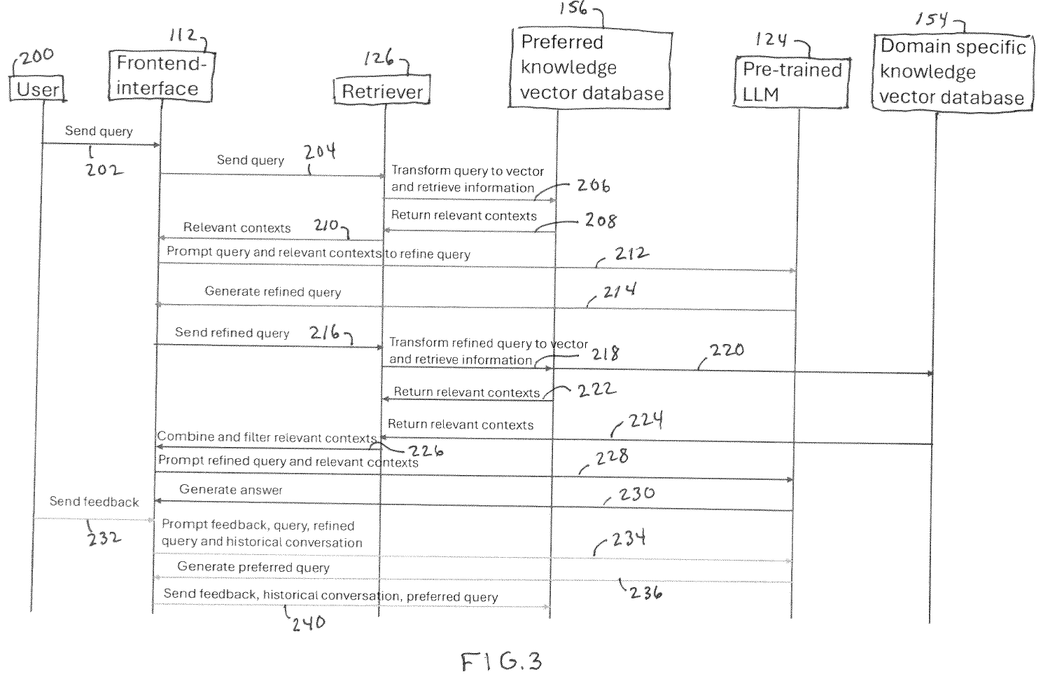

FIG. 3 is a swimlane flowchart that illustrates the steps of a RAG method executed by the RAG system of FIG. 2, according to an embodiment of the present disclosure. In step 202, a user 200 inputs a query to the front-end user interface 112 of the internet website. In step 204, the query is transmitted by the front-end user interface 112 to the retriever module 126 running on the back-end server 122 of the website. In step 206, the vector transformation submodule 128 of the retriever module 126 transforms the query into a vector and the vector search submodule 130 of the retriever module 126 uses the vector to perform a semantic search in the preferred knowledge vector database 156 of the vector storage platform module 152 of the pipeline server 140, for contexts (all users' historical conversations, feedback, preferred queries, and retrieved relevant contexts) that are relevant to the vector representing the query. In step 208, the preferred knowledge vector database 156 returns the relevant contexts in text form to the vector search submodule 130 of the retriever module 126. In step 210, the vector search submodule 130 of the retriever module 126 transmits the relevant contexts to the front-end user interface 112. In step 212, the front-end user interface 112 transmits a prompt template containing the relevant contexts and the query (of step 202) to the pre-trained LLM 124 running on a back-end server 122 of the website to generate one or more new refined queries In response to the prompt, the pre-trained LLM 124 in step 214 generates the one or more new refined queries based on the original query (the query inputted by the user in step 202) and the relevant contexts, and transmits the one or more new refined queries to front-end user interface 112, wherein a refined query is defined as a modified or enhanced version of a user's initial query, intended to improve the accuracy and relevance of information retrieved from the knowledge base. In step 216, the front-end user interface 112 transmits the one or more new refined queries to the retriever module 126. In step 218, the vector transformation submodule 128 of the retriever module 126 transforms the one or more new refined queries into vectors and the vector search submodule 130 of the retriever module 126 uses the vectors to perform a semantic search in the preferred knowledge vector database 156 of the vector storage platform module 152 of the external pipeline server 140, for contexts (all users' historical conversations, feedback, preferred queries, and retrieved relevant contexts) that are relevant to the vectors representing the one or more new refined queries. In step 220, the vector search submodule 130 of the retriever module 126 also uses the vectors representing the one or more new refined queries, to perform a semantic search of the domain-specific knowledge vector database 154 of the vector storage platform module 152 of the external pipeline server 140, for contexts (images; text documents; PowerPoint Presentations; PDFs; graphs; diagrams, etc.) that are relevant to the vectors representing the one or more new refined queries. In step 222, the preferred knowledge vector database 156 returns the relevant contexts (all users' historical conversations, feedback, preferred queries, and retrieved relevant contexts) to the vector search submodule 130 of the retriever module 126. In step 224, the domain-specific knowledge vector database 156 returns the relevant contexts (images; text documents; PowerPoint Presentations; PDFs; graphs; diagrams, etc.) to the vector search submodule 130 of the retriever module 126. In step 226, the vector search submodule 130 of the retriever module 126 combines the relevant contexts received from the preferred knowledge vector database 156 and the domain-specific knowledge vector database 154, filters out any redundant contexts, and transmits the relevant contexts remaining after combining and filtering them, to the front-end user interface 112 in text form. In step 228, the front-end user interface 112 transmits a template containing the relevant contexts and the new refined query to the pre-trained LLM 124 running on a back-end server 122 of the website. In step 230, the pre-trained LLM 124 is configured to generate an answer in text form and transmits it to the front-end user interface 112 for viewing by the user 200. In step 232, the user inputs feedback including without limitation user comments and ratings, to the front-end user interface 112 of the internet website. In some embodiments, the front-end user interface 112 will prompt the user to provide feedback if the user does not provide feedback. In step 234, the front-end user interface 112 transmits a template containing the user's feedback, the original query, the new refined query, the retrieved contexts, and the historical conversation to the pre-trained LLM 124. In step 236, the pre-trained LLM 124 infers one or typically multiple preferred queries and transmits it/them to the front-end user interface 112. In step 240, the front-end user interface 112 aggregates the user's feedback, the one or more preferred queries, the retrieved contexts, and the historical conversation into a document, and stores this document in the user preference bucket 148 of the storage platform submodule 144 running on the data pipeline server 140. The user preference bucket 148 sends this document to the vector transformation submodule 150 for vector transformation, which transforms the document into a vector, and transmits the vector to the preferred knowledge vector database 156 for storage therein.

The above-described query refinement process, which is based on user feedback in the RAG system and method of the present disclosure, is implemented without additional training and thereby improves the query, which controls complete and accurate knowledge retrieval.

Table 2 below sets forth a RAG algorithm according to an illustrative embodiment of the present disclosure, which can be used to implement the RAG method described with respect to FIG. 3.

```
TABLE 2
Algorithm of the present disclosure: Optimized Preferred Query Refinement
(OPQR) in RAG
Initial: Preferred knowledge vector database P = Ø
Require: Generator LLM M, Retriever R, external domain-specific knowledge
vector database B={d₁,..., d_{N}}
  301Input: User query q
  302Retriever R does semantic search over P to retrieve top-k documents
    D = {p₁, ... , pₖ} given q
  303Prompt engineering: system prompt + q + D to prompt LLM M
  304M generates refined query q*
  305Retriever R does semantic search over P and B to retrieve top-k
    documents F = {pᵢ}_{i=1,...,k} ∪ {d₁, ... , dₖ} given q*
  306Combine all retrieved documents in F and filter the redundant
    documents to obtain F*
  307Prompt engineering: q* + F* and prompt LLM M
  308LLM M generates answer y
  309User provides feedback u
  310Prompt engineering: q + q* + F* + y + u to prompt LLM M
  311LLM M generates preferred query n
  312Create a document p = (q, n, F*, y, u)
  313Transform p into vector and index p to P: update P = P ∪ p
```

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method for answering a user query, the method comprising:
with a Large Language Model (LLM) of a computing device, generating a refined query based on the user query and a first set of contexts relevant to the user query retrieved from a first database;
retrieving a second set of contexts from the first database that are relevant to the refined query;
retrieving a third set of contexts from a second database that are relevant to the refined query;
with the LLM, generating an answer to the refined query based on the second and third sets of contexts; and
with the LLM, generating a preferred query based on feedback from the user, the query, the refined query, and historical conversations.

2. The method according to claim 1, further comprising with a user interface, sending the feedback from the user, the historical conversations, and the preferred query received from the LLM, to the first database for storage.

3. The method according to claim 2, wherein the first database comprises a preferred knowledge vector database.

4. The method according to claim 1, wherein the first database comprises a preferred knowledge vector database, from which the first set of contexts that are relevant to the user query and the second set of contexts that are relevant to the refined query, are retrieved.

5. The method according to claim 4, wherein the second database comprises a domain-specific knowledge vector database, from which the third set of contexts that are relevant to the refined query, are retrieved.

6. The method according to claim 1, wherein the second database comprises a domain-specific knowledge vector database, from which the third set of contexts that are relevant to the refined query, are retrieved.

7. The method according to claim 1, further comprising receiving user feedback about the answer generated by the LLM, at a user interface.

8. The method according to claim 7, further comprising sending, with the user interface, the feedback from the user, the query, the refined query, and historical conversations to the LLM prior to generating the preferred query.

9. The method according to claim 1, further comprising sending, with a user interface, the feedback from the user, the query, the refined query, and historical conversations to the LLM prior to generating the preferred query.

10. The method according to claim 1, wherein the retrieving of the first set of contexts, the retrieving of the second set of contexts, and the retrieving of the third set of contexts, are each performed with a retriever module.

11. The method according to claim 10, wherein the computing device includes the retriever module.

12. A system for answering a user query, the system comprising:
a computing device having a Large Language Model (LLM);
first and second databases; and
a user interface;
wherein the LLM generates a refined query based on the user query and a first set of contexts retrieved from the first database and generates an answer to the refined query based on a second set of contexts retrieved from the first database that are relevant to the refined query and a third set of contexts retrieved from the second database that are relevant to the refined query;
wherein the user interface receives user feedback about the answer generated by the LLM;
wherein the LLM generates a preferred query based on the user feedback, the query, the refined query, and historical conversations received from the user interface.

13. The system according to claim 12, wherein the user interface sends the feedback from the user, the historical conversations, and the preferred query received from the LLM to the first database for storage.

14. The system according to claim 13, wherein the first database comprises a preferred knowledge vector database.

15. The system according to claim 12, wherein the first database comprises a preferred knowledge vector database, which provides the first set of contexts that are relevant to the user query and the second set of contexts that are relevant to the refined query.

16. The system according to claim 15, wherein the second database comprises a domain-specific knowledge vector database, which provides the third set of contexts that are relevant to the refined query.

17. The system according to claim 12, wherein the second database comprises a domain-specific knowledge vector database, which provides the third set of contexts that are relevant to the refined query.

18. The system according to claim 12, wherein the user interface receives the user feedback about the answer generated by the LLM.

19. The system according to claim 18, wherein the user interface sends the feedback from the user, the query, the refined query, and historical conversations to the LLM prior to generating the preferred query.

20. The system according to claim 12, wherein the user interface sends the feedback from the user, the query, the refined query, and historical conversations to the LLM prior to generating the preferred query.
